(19) United States
(12) Patent Application Publication
(10) Pub. No.: US 2026/0270707 A1
(43) Pub. Date: Sep. 10, 2026

(54) VULNERABILITY ORIENTED CONFIGURATION MANAGEMENT

(71) Applicant: Dell Products L.P., Round Rock, TX (US)

(72) Inventors: Zhengchu Liu, Taipei City (TW); Vincent Joseph Thyng, Des Moines, WA (US)

(21) Appl. No.: 19/072,122

(22) Filed: Mar. 6, 2025

(51) Int. Cl. H04W 12/126; H04W 12/67

(52) U.S. Cl. CPC H04W 12/126; H04W 12/67

(57) ABSTRACT

Vulnerability oriented configuration management (e.g., using a computerized tool), is enabled. For example, a system can comprise at least one processor and at least one memory that stores executable instructions that, when executed by the processor, facilitate performance of operations. The operations can comprise determining configuration data representative of configurations of remote devices communicatively coupled to the system, retrieving, from a common vulnerability and exposure (CVE) entity, a CVE publication comprising a CVE determined, using the configuration data, to be applicable to a remote device of the remote devices, generating, using machine learning based on previous remediations of previous CVE publications applicable to other remote devices other than the remote device, a remote device update determined to prevent exposure of the remote device to the CVE, and applying the remote device update to the remote device.

### BACKGROUND

In the area of vulnerability management, existing solutions focus on detecting and reporting vulnerabilities. Detection of a common vulnerability and exposure (CVE) is typically carried out by multiple scanning agents installed on the targets.

The above-described background relating to CVEs is merely intended to provide a contextual overview of some current issues and is not intended to be exhaustive. Other contextual information may become further apparent upon review of the following detailed description.

### BRIEF DESCRIPTION OF DRAWINGS

FIG. 1 is a block diagram of an example system in accordance with one or more example embodiments described herein.

FIG. 2 is a block diagram of example computer executable components in accordance with one or more example embodiments described herein.

FIG. 3 is a block diagram of example computer executable components in accordance with one or more example embodiments described herein.

FIG. 4 is a block flow diagram of example vulnerability oriented configuration management in accordance with one or more example embodiments described herein.

FIG. 5 is a block flow diagram of example vulnerability oriented configuration management in accordance with one or more example embodiments described herein.

FIG. 6 is a block flow diagram for a process associated with vulnerability oriented configuration management in accordance with one or more example embodiments described herein.

FIG. 7 is a block flow diagram for a process associated with vulnerability oriented configuration management in accordance with one or more example embodiments described herein.

FIG. 8 is a block flow diagram for a process associated with vulnerability oriented configuration management in accordance with one or more example embodiments described herein.

FIG. 9 is an example, non-limiting computing environment in which one or more embodiments described herein can be implemented.

FIG. 10 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As mentioned, existing solutions for vulnerability management focus on detecting and reporting vulnerabilities and detection of a CVE is typically carried out by multiple scanning agents installed on the targets. However, with textual recommendations, such existing solutions do not actively perform remediation.

Separate conventional configuration management tools are service-oriented. Such conventional configuration management tools make configuration states based on the requirement(s) of deploying a corresponding application service. Existing solutions, however, result in remote devices being vulnerable to CVEs for a significant amount of time, potentially compromising the remote device.

In this regard, system response to CVEs can be improved in various ways, and various embodiments are described herein to this end and/or other ends.

According to an example embodiment, a system can comprise at least one processor, and at least one memory that stores executable instructions that, when executed by the at least one processor, facilitate performance of operations, comprising determining configuration data representative of configurations of remote devices communicatively coupled to the system, retrieving, from a common vulnerability and exposure (CVE) entity, a CVE publication comprising a CVE determined, using the configuration data, to be applicable to a remote device of the remote devices, generating, using machine learning based on previous remediations of previous CVE publications applicable to other remote devices other than the remote device, a remote device update determined to prevent exposure of the remote device to the CVE, and applying the remote device update to the remote device.

In one or more example embodiments, the machine learning can comprise reinforcement learning.

In one or more example embodiments, the above operations can further comprise retrieving, from a group of CVE entities comprising the CVE entity, a group of CVE publications comprising CVEs determined to be applicable to the remote device, wherein the group of CVE publications comprises the CVE publication. In this regard, the operations can further comprise normalizing respective risk scores of the CVEs, resulting in normalized risk scores. In one or more example embodiments, the remote device update can be generated based on the normalized risk scores.

In one or more example embodiments, the remote device update can comprise a configuration update applicable to the remote device. In further embodiments, the remote device update can comprise a software code change applicable to the remote device.

In one or more example embodiments, the CVE publication can be retrieved according to a defined CVE publication refresh frequency policy.

In one or more example embodiments, the remote device update can be applied to the remote device via a defined secure shell protocol.

In another example embodiment, a non-transitory machine-readable medium can comprise executable instructions that, when executed by at least one processor, facilitate performance of operations, comprising determining configuration data representative of configurations of remote target devices, retrieving, from a common vulnerability and exposure (CVE) entity, a CVE publication comprising a CVE determined, using the configuration data, to be applicable to a remote target device of the remote target devices, using machine learning based on previous remediations of previous CVE publications applicable to other remote target devices other than the remote target device, generating, a remote target device update determined to mitigate exposure of the remote target device to the CVE, and applying the remote target device update to the remote target device.

In one or more example embodiments, the above operations can further comprise determining a group of remote target devices, comprising the remote target device, that are applicable to the CVE, and applying the remote target device update to the group of remote target devices.

In one or more example embodiments, the above operations can further comprise, in response to receiving an acknowledgement from the remote target device that the remote target device update has been successfully applied, registering the remote target device as successfully updated.

In one or more example embodiments, the remote target device update can be transmitted via a defined secure communication channel.

In one or more example embodiments, the remote target device update can be applied to a kernel of the remote target device.

In one or more example embodiments, the remote target device can be instantiated via cloud computing equipment.

In one or more example embodiments, the remote target device can comprise a storage appliance or a compute appliance.

In yet another example embodiment, a method can comprise determining, by a system comprising at least one processor, remote device data representative of configurations of remote devices communicatively coupled to the system, retrieving, by the system from a common vulnerability and exposure (CVE) entity, a CVE publication comprising a CVE determined, using the remote device data, to be applicable to a remote device of the remote devices, generating, by the system using machine learning based on previous remediations of previous CVE publications applicable to other remote devices other than the remote device, a remote device update determined to mitigate or eliminate exposure of the remote device to the CVE, and facilitating, by the system, application of the remote device update to the remote device.

In one or more example embodiments, the system and the remote device can be located within different respective physical structures.

In one or more example embodiments, the remote device data can be repeatedly updated by the system.

In one or more example embodiments, the remote device can comprise a server.

One impactful downside to leveraging Linux-based operating systems in remote devices, for instance, is that any CVE that is discovered in the underlying operating system would also be inherently present in a remote device utilizing a corresponding Linux-based operating system. Upon a determination that a remote device is vulnerable to a CVE, the vulnerability should be addressed in a timely manner, for instance, to eliminate the exposure of the respective remote appliance device to the CVE. In some industries, it is even a legal requirement to address CVEs within a defined time frame, and response to CVEs can also be part of a service level agreement (SLA) and/or vendor agreement. However, it is challenging to generate a security patch in a short amount of time. For example, there can be significant development and validation time required to generate the security patch (e.g., updating the underlying operating system). Further, humans are inherently slow programmers, and even the fastest humans are still often unable to generate a security patch quickly enough to prevent vulnerabilities quickly enough to prevent potentially irreversible exposure to a CVE.

Embodiments described herein, in an automated fashion, bridge the gap between CVE detection and system remediation. In various embodiments described herein, the latest vulnerabilities from public catalogs are filtered, by a system, by target inventory, mapped into configuration states or code-based remediations, and enforced on remote devices (e.g., target servers) herein.

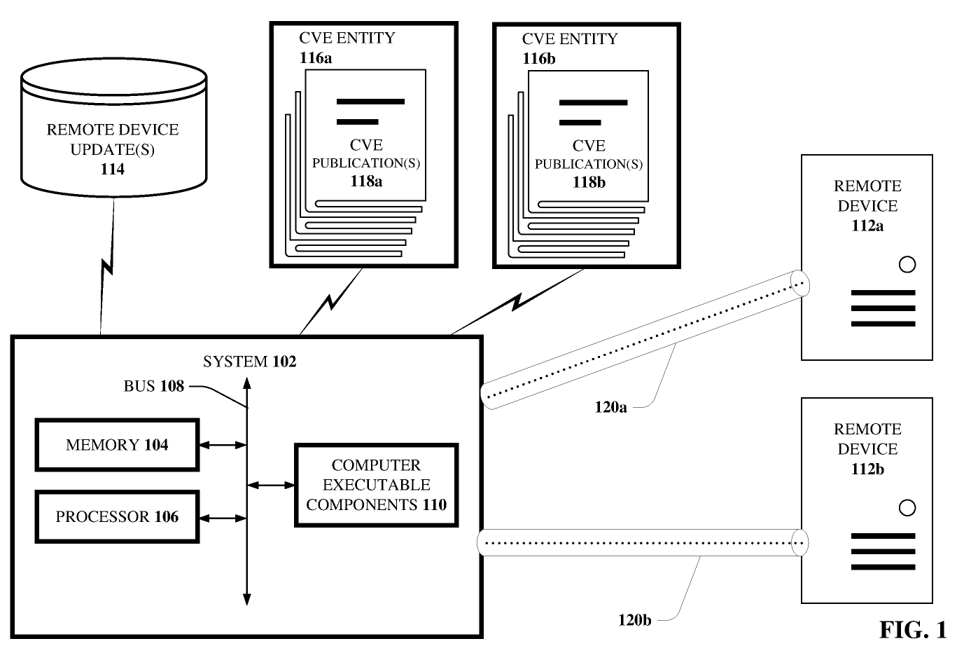

Turning now to FIG. 1, there is illustrated an example, non-limiting system 102 in accordance with one or more example embodiments herein. System 102 can comprise a computerized tool, which can be configured to perform various operations relating to vulnerability-oriented configuration management (e.g., of remote devices described herein). The system 102 can comprise one or more of a variety of components, such as memory 104, processor 106, bus 108, and/or computer executable components 110. In various embodiments, one or more of the memory 104, processor 106, bus 108, and/or computer executable components 110 can be communicatively or operably coupled (e.g., over a bus or wireless network) to one another to perform one or more functions of the system 102. In various example embodiments, the system 102 can comprise and/or be communicatively coupled to remote devices (e.g., remote device 112a, remote device 112b, etc.), CVE entities (e.g., CVE entity 116a, CVE entity 116b, etc.), and/or one or more device update(s) 120 (e.g., applicable to remote device(s) 112 herein). In further embodiments, a remote device 112 can comprise a respective instance of the system 102.

In various example embodiments, the remote device (e.g., remote device 112) has been instantiated via cloud computing equipment. For example, the system 102 and the remote device (e.g., remote device 112) can be located within different respective physical structures (e.g., different buildings). For instance, the system 102 can be located in state A, and the group of remote devices 112 can be scattered across states A, B, C, and D in respective physical structures (e.g., buildings).

In various example embodiments, the remote device (e.g., remote device 112) can comprise a storage appliance, compute appliance, a server, or another suitable device. For example, the remote device 112 can be instantiated at a customer facility while the system 102 is instantiated at a supplier facility. In one or more example embodiments, a remote device 112 can comprise a storage appliance, a compute appliance, a server, or any suitable device that utilizes an operating system. Storage appliances herein can comprise hardware devices that provide data storage and management capabilities. Compute appliances herein can comprise hardware devices that enable processing and computing operations. In various example embodiments, the remote device 112 can comprise cloud computing equipment.

In various example embodiments, the remote device update(s) 114 can comprise a repository (e.g., a data storage) of one or more remote device updates generated by the system 102.

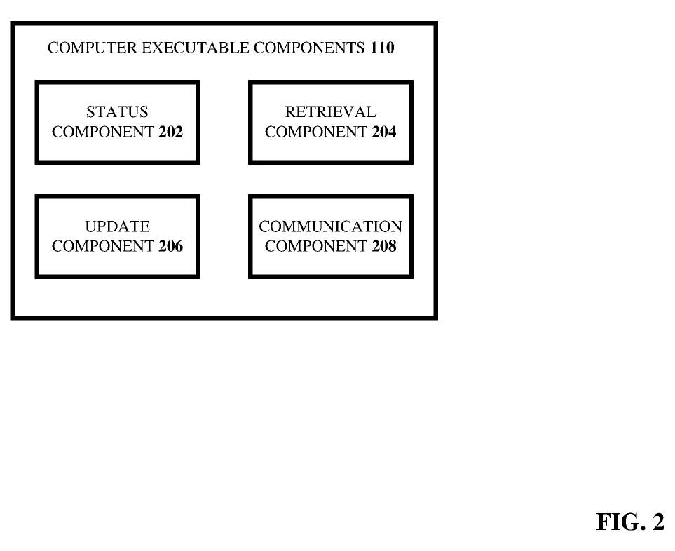

FIG. 2 illustrates a block diagram of example, non-limiting computer executable components 110 that can facilitate vulnerability-oriented configuration management in accordance with one or more embodiments described herein. Repetitive description of like elements employed in other embodiments described herein is omitted for sake of brevity. As shown in FIG. 2, the one or more computer executable components 110 can comprise status component 202, retrieval component 204, update component 206, and/or communication component 208.

In various example embodiments, the status component 202 can determine configuration data representative of configurations of remote devices (e.g., one or more of the remote device 112) communicatively coupled to the system (e.g., system 102). Such configuration data can comprise, for instance, model number, serial number, software version, hardware version, subcomponents, connected peripherals, configuration instance/version, and/or other suitable configuration data applicable to a remote device 112 herein. It is noted that, in various example embodiments, the configuration data can be repeatedly updated by the system 102 (e.g., via the status component 202), for instance, over the secure communication channel 120.

In various example embodiments, the retrieval component 204 can retrieve, from a common vulnerability and exposure (CVE) entity (e.g., CVE entity 116), a CVE publication (e.g., CVE publication 118) comprising a CVE determined, using the configuration data, to be applicable to a remote device (e.g., remote device 112) of the remote devices. For instance, a CVE entity 116 herein can comprise the MITRE Corporation and/or a corresponding device of the MITRE Corporation, CVSS (common vulnerability scoring system) and/or a corresponding device of CVSS, and/or EPSS (exploit prediction scoring system) and/or a corresponding device of EPSS. It is noted that the MITRE Corporation, CVSS, and EPSS typically maintain or comprise a database of published vulnerabilities. It is further noted, however, that CVE entities herein are not limited to MITRE, CVSS, or EPSS CVE entities. Other example CVE entities can comprise the National Vulnerability Database, Exploit Database, CERT/CC, or another suitable CVE entity. In various example embodiments, the retrieval component 204 can retrieve the CVE publication 118 form the CVE entity 116 continuously, at defined intervals, or at random intervals, for instance, over a defined communication channel. In this regard, the CVE entity 116 can be communicatively coupled to the system 102. In further embodiments, the retrieval component 204 can retrieve, from a group of CVE entities comprising the CVE entity (e.g., CVE entity 116), a group of CVE publications 118 (e.g., CBE publication 118a and CVE publication 118b) comprising CVEs determined to be applicable to the remote device 112. In this regard, the group of CVE publications 118 can comprise the CVE publication (e.g., a CVE publication 118a).

In one or more example embodiments, the CVE publication 118 can be retrieved (e.g., via the retrieval component 204) according to a defined CVE publication refresh frequency policy (e.g., applicable to the system 102 and/or the remote device 112). It is noted that, in various example embodiments, the CVE publication 118 can be repeatedly updated by the system 102 (e.g., via the retrieval component 204), for instance, over the secure communication channel 120. In further embodiments, the retrieval component 204 can retrieve CVE publications herein at defined intervals or at random intervals.

In various example embodiments, the update component 206 can generate, using machine learning based on previous remediations of previous CVE publications applicable to other remote devices other than the remote device (e.g., remote device 112), a remote device update (e.g., remote device update 114) determined to prevent exposure of the remote device (e.g., remote device 112) to the CVE. In one or more example embodiments, such machine learning can comprise reinforcement learning. In one or more example embodiments, the remote device update (e.g., remote device update 114) can comprise a configuration update applicable to the remote device (e.g., remote device 112). For instance, the remote device update can comprise an update relating to a file permission change on the remote device 112, an update relating to a user permission change on the remote device 112, an update relating to an opening or a closing of a port of the remote device 112, an update relating to an enabling or a disabling of a feature of the remote device 112, and/or another suitable remote appliance device configuration update applicable to the remote device 112. In further embodiments, the remote device update (e.g., remote device update 114) can comprise a software code change applicable to the remote device (e.g., remote device 112).

In various embodiments, the update component 206 can enable automated program repair (APR) and/or code generation. In this regard, the update component 206 can utilize one or more machine learning models, for instance, which can be trained source code applicable to remote devices herein. Such machine learning models can learn coding patterns, syntax, and/or best coding practices, for instance, to generate and repair code. Further, the machine learning based models can learn from past bug reports and/or fixes, for instance, to determine software remediations. Additionally, or alternatively, the update component 206 can utilize transformer-based models, in which large language models (e.g., LLMs) can generate and correct code based on natural language descriptions or error messages (e.g., such as those contained in the CVE publications 118). Further, the update component 206 can utilize reinforcement learning (RL), for instance, to explore and iteratively improve code remediations. In various example embodiments, the update component 206 can facilitate test-driven repair (TDR), in which the update component 206 can generate potential patches and validate the potential patches, for instance, using unit tests. In this regard, if a generated remediation passes the unit test suite without introducing new errors, it can be considered a valid remediation.

In various example embodiments, the communication component 208 can apply the remote device update (e.g., remote device update 114) to the remote device (e.g., remote device 112). In one or more example embodiments, the remote device update can be applied (e.g., via the communication component 208) to the remote device (e.g., remote device 112) via a defined secure shell (sshd) protocol. In further embodiments, the remote device update (e.g., remote device update 114) can be transmitted (e.g., via the communication component 208) via a defined secure communication channel 120. The secure communication channel 120 can comprise, for instance, a private and protected pathway between the system 102 and the remote device 112. In one or more embodiments, data transmitted via the secure communication channel 120 can be encrypted and/or enable end-to-end security.

In one or more example embodiments, the remote target update (e.g., remote device update 114) can be applied to a kernel of the remote device (e.g., remote device 112). In this regard, embodiments herein can comprise an embedded program in the kernel space of the remote device 112, for instance, to respond to CVE events. The secure communication channel 120 can be leveraged, for instance, to eliminate or minimize the exposure to a CVE in an automated manner, without user (e.g., customer) involvement, thus, avoiding a lengthy security patch development and validation process and/or manual workarounds. Because, in some example embodiments, the secure communication channel 120 can be always-on, configuration and/or software updates, once available from the system 102, can be immediately transmitted from the system 102 to the remote device 112. The foregoing enables configuration or software changes and updates to be applied significantly faster than otherwise possible, thus mitigating exposure to CVEs and protecting remote devices 112 described herein.

In various example embodiments, the system 102 (e.g., via status component 202, retrieval component 204, and/or another suitable component) can determine a group of remote devices, comprising the remote device (e.g., remote device 112), that are applicable to the CVE. In this regard, the communication component 208 can then apply the remote device update (e.g., remote device update 114) to the group of remote target devices. Stated otherwise, the system 102 can apply the remote device update 114 to a plurality of remote devices 112 at once (e.g., during a single update event or single update instance).

In various example embodiments, the status component 202 can, in response to receiving an acknowledgement from the remote device (e.g., remote device 112) that the remote device update (e.g., remote device update 114) has been successfully applied, register the remote device (e.g., remote device 112) as successfully updated. Such a registration can be recorded by the status component 202, for instance, in memory 104. In various example embodiments, the status component 202 can receive the acknowledgement via the secure communication channel 120.

Various example embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or machine learning components herein can comprise artificial intelligence component(s) which can employ an artificial intelligence (AI) model and/or machine learning (ML) or an ML model that can learn to perform the above or below described functions (e.g., via training using historical training data and/or feedback data).

In some embodiments, system 102 can comprise an AI and/or ML model that can be trained (e.g., via supervised and/or unsupervised techniques) to perform the above or below-described functions using historical training data comprising various context conditions that correspond to various augmented network optimization operations. In this example, such an AI and/or ML model can further learn (e.g., via supervised and/or unsupervised techniques) to perform the above or below-described functions using training data comprising feedback data, where such feedback data can be collected and/or stored (e.g., in memory) by the system 102. In this example, such feedback data can comprise the various instructions described above/below that can be input, for instance, to a system herein, over time in response to observed/stored context-based information.

The system 102 can initiate an operation(s) associated with a based on a defined level of confidence determined using information (e.g., feedback data). For example, based on learning to perform such functions described above using feedback data, performance information, and/or past performance information herein, the system 102 herein can initiate an operation associated with determining various thresholds herein (e.g., a motion pattern thresholds, input pattern thresholds, similarity thresholds, authentication signal thresholds, audio frequency thresholds, or other suitable thresholds).

In an example embodiment, the system 102 can perform a utility-based analysis that factors cost of initiating the above-described operations versus benefit. In this embodiment, the system 102 can use one or more additional context conditions to determine various thresholds herein.

To facilitate the above-described functions, the system 102 herein can perform classifications, correlations, inferences, and/or expressions associated with principles of artificial intelligence. For instance, the system 102 can employ an automatic classification system and/or an automatic classification. In one example, the system 102 can employ a probabilistic and/or statistical-based analysis (e.g., factoring into the analysis utilities and costs) to learn and/or generate inferences. The system 102 can employ any suitable machine-learning based techniques, statistical-based techniques, and/or probabilistic-based techniques. For example, the system 102 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the system 102 can perform a set of machine-learning computations. For instance, the system 102 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

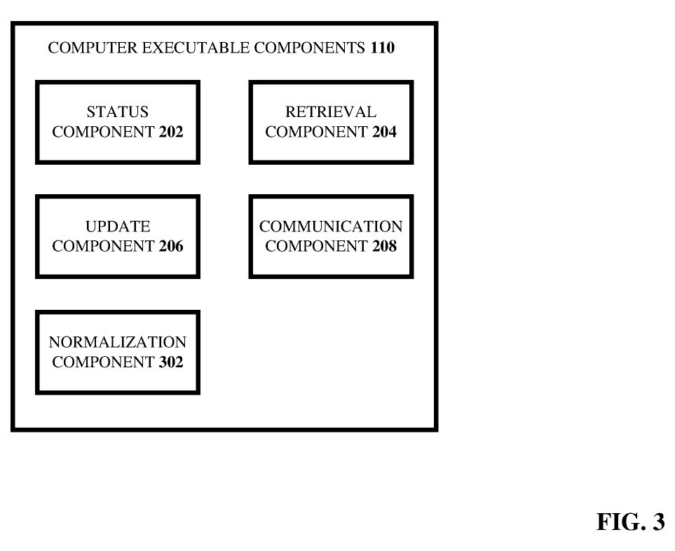

FIG. 3 illustrates a block diagram of example, non-limiting computer executable components 110 that can facilitate vulnerability oriented configuration management in accordance with one or more embodiments described herein. Repetitive description of like elements employed in other embodiments described herein is omitted for sake of brevity. As shown in FIG. 3, the one or more computer executable components 110 can comprise status component 202, retrieval component 204, update component 206, communication component 208, and/or normalization component 302.

As previously discussed, in various example embodiments, CVSS, EPSS, and/or other suitable scoring methods can be utilized by CVE entities 116 herein in order to score and access CVEs. In various example embodiments, the retrieval component 204 can retrieve, from a group of CVE entities comprising the CVE entity (e.g., CVE entity 116), a group of CVE publications comprising CVEs determined to be applicable to the remote device, wherein the group of CVE publications comprises the CVE publication (e.g., CVE publication 118). In this regard, the normalization component 302 can normalize respective risk scores of the CVEs, resulting in normalized risk scores. Further in this regard, the remote device update 114 can be generated (e.g., via the update component 206) based on the normalized risk scores.

In order to normalize the risk scores, the normalization component 302 can perform one or more of a variety of data normalization functions associated with CVEs herein. For instance, the normalization component 302 can perform schema mapping and standardization, in which the normalization component 302 can identify common fields across CVE datasets, map data to a standard schema, and/or utilize defined data catalogs or ontology mapping for semantic consistency. The normalization component 302 can further perform CVE data cleaning, in which the normalization component 302 can detect and remove duplicate records, handle missing data by imputing missing values (e.g., mean, median, mode, predictive models, etc.) and/or use placeholders (e.g., NULL, N/A) or drop incomplete records, resolve inconsistencies by convert formats, standardize units, and/or normalize text fields (e.g., case sensitivity, typos, encoding issues). The normalization component 302 can further perform CVE data transformation, in which the normalization component 302 can perform CVE scaling and normalization, in which the normalization component 302 can perform min-max scaling (e.g., values between 0 and 1) and/or z-score normalization (e.g., mean = 0, std deviation = 1). The normalization component 302 can then perform data integration and storage, in which the normalization component 302 can merge CVE datasets using unique identifiers, store the data in a unified database (e.g., in memory 104), and/or perform data versioning to track CVE changes over time.

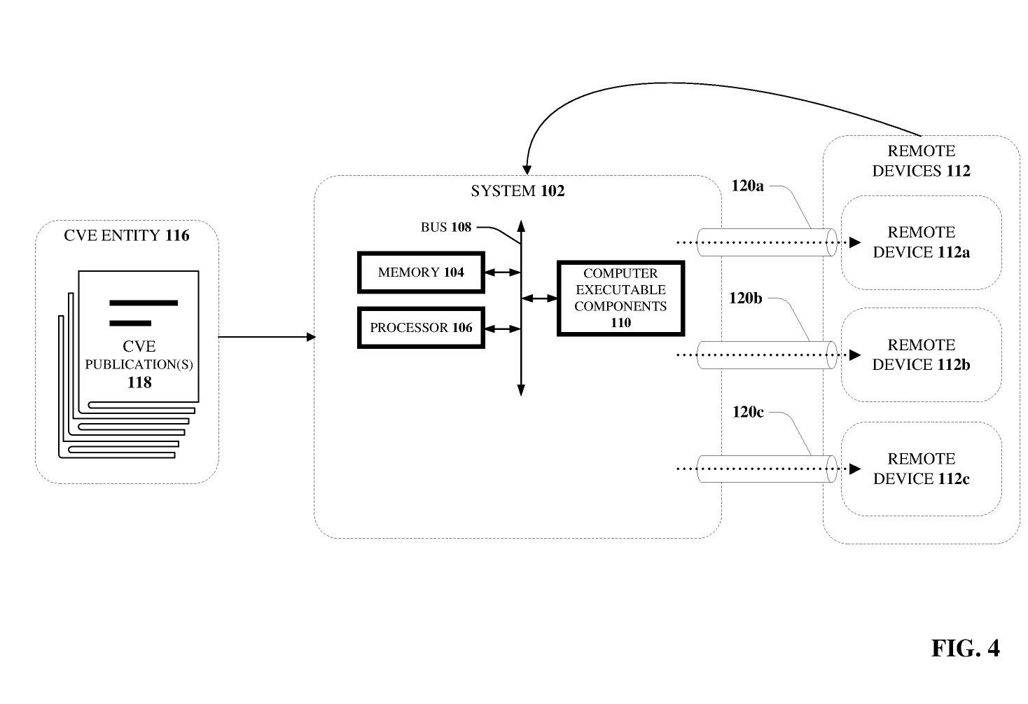

FIG. 4 is a block flow diagram of example vulnerability oriented configuration management in accordance with one or more example embodiments described herein. For example, a CVE can be identified and/or published via a CVE entity 116 (e.g., a computer, server, mobile device, or another suitable device). For example, the system 102 and/or CVE entity 116 can be registered with one another so that CVE publications 118 can be automatically pushed from the CVE entity 116 to the system 102. In this regard, the system 102 can be notified (e.g., via the CVE entity 116) of a corresponding CVE publication 118. In an example, the system 102 can receive a CVE publication 118. The system 102 can identify remote devices 112 that are exposed to the respective CVE described in the CVE publication 118. For example, the system 102 can determine a group of remote devices 112, comprising the remote device 112, that are exposed to a CVE identified in the CVE publication 118. In this regard, the remote devices 112 can be registered with the system 102, and the system 102 can compare remote device registrations (e.g., and corresponding data such as model number, serial number, software version, etc.) to corresponding data in the CVE publication 118, for instance, in order to determine the remote devices 112 that are subject to the CVE publication 118. Remote device updates (e.g., applicable to the identified vulnerable remote appliance devices(s) 112) that eliminate exposure to this CVE can be determined (e.g., via the update component 206), and the system 102 can then push these remote device updates 114 to corresponding remote devices 112, for instance, via respective secure communication channel(s) 120. For example, the system 102 can send a remote device update 114 to the remote device 112a via the secure communication channel 120a, the system 102 can send the remote device update 114 to the remote device 112b via the secure communication channel 120b, the system 102 can send the remote device update 114 to the remote device 112c via the secure communication channel 120c, and so on.

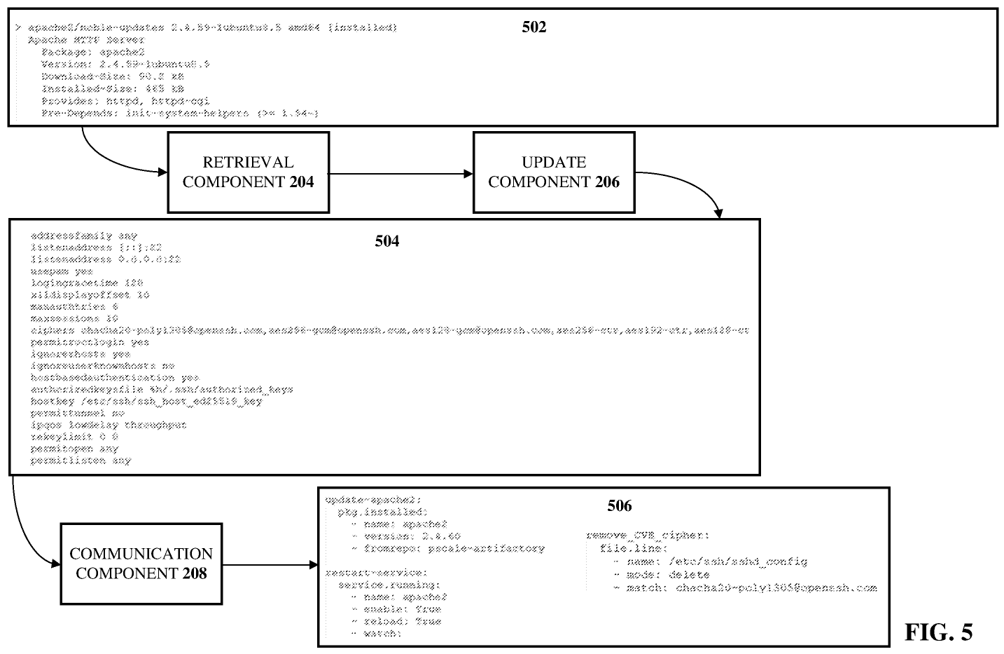

FIG. 5 is a block flow diagram of example vulnerability oriented configuration management in accordance with one or more example embodiments described herein. For example, CVE 502 can be identified as applicable to a remote device 112 herein via the retrieval component 204. In this regard, the retrieval component 204 can retrieve, from a common vulnerability and exposure (CVE) entity (e.g., CVE entity 116), a CVE publication (e.g., CVE publication 118) comprising a CVE determined, using the configuration data, to be applicable to a remote device (e.g., remote device 112). A configuration file 504 (e.g., a remote device update 114) can be generated by the update component 206. It is noted that the update component 206 can additionally, or alternatively, generate a software code change applicable to the remote device (e.g., remote device 112) (e.g., in addition to or instead of a configuration change). The communication component 208 can then transmit instructions 506 to the remote device 112, for instance, to apply the configuration file 504 or another suitable remediation. In one or more example embodiments, the remote device update 114 (e.g., via the configuration file 504 or another suitable remediation) can be applied (e.g., via the communication component 208) to the remote device (e.g., remote device 112) via a defined sshd protocol. In further embodiments, the remote device update 114 (e.g., via the configuration file 504 or another suitable remediation) can be transmitted (e.g., via the communication component 208) to the remote device 112 via a defined secure communication channel 120.

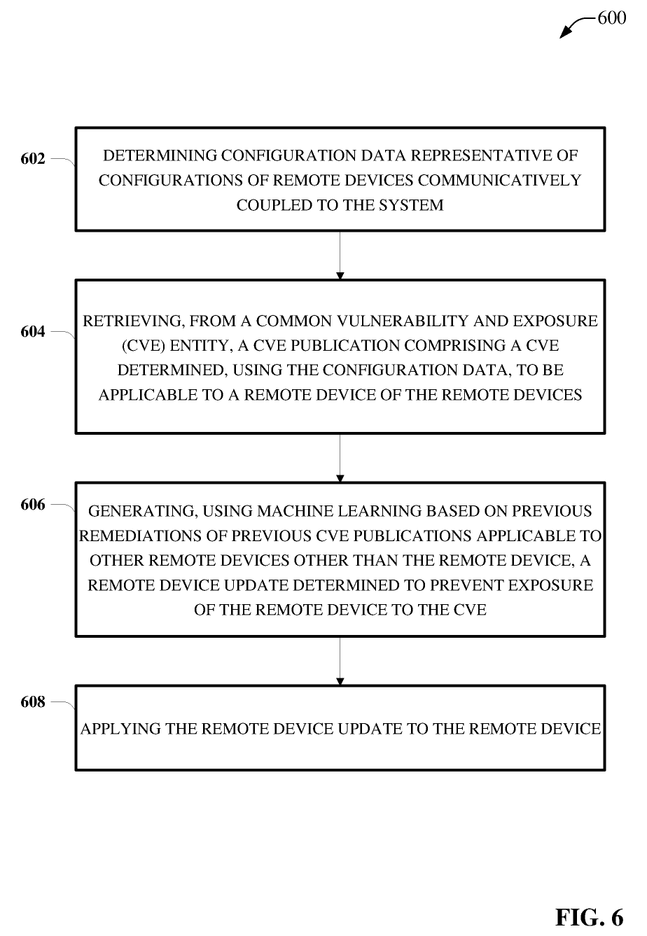

FIG. 6 illustrates a block flow diagram for a process 600 associated with vulnerability oriented configuration management in accordance with one or more embodiments described herein. At 602, the process 600 can comprise determining (e.g., via the status component 202) configuration data representative of configurations of remote devices (e.g., one or more of the remote devices 112) communicatively coupled to the system (e.g., system 102). At 604, the process 600 can comprise retrieving (e.g., via the retrieval component 204), from a common vulnerability and exposure (CVE) entity (e.g., CVE entity 116), a CVE publication (e.g., CVE publication 118) comprising a CVE determined, using the configuration data, to be applicable to a remote device (e.g., remote device 112) of the remote devices. At 606, the process 600 can comprise generating (e.g., via the update component 206), using machine learning based on previous remediations of previous CVE publications applicable to other remote devices other than the remote device (e.g., remote device 112), a remote device update (e.g., remote device update 114) determined to prevent exposure of the remote device (e.g., remote device 112) to the CVE. At 608, the process 600 can comprise applying (e.g., via the communication component 208) the remote device update (e.g., remote device update 114) to the remote device (e.g., remote device 112).

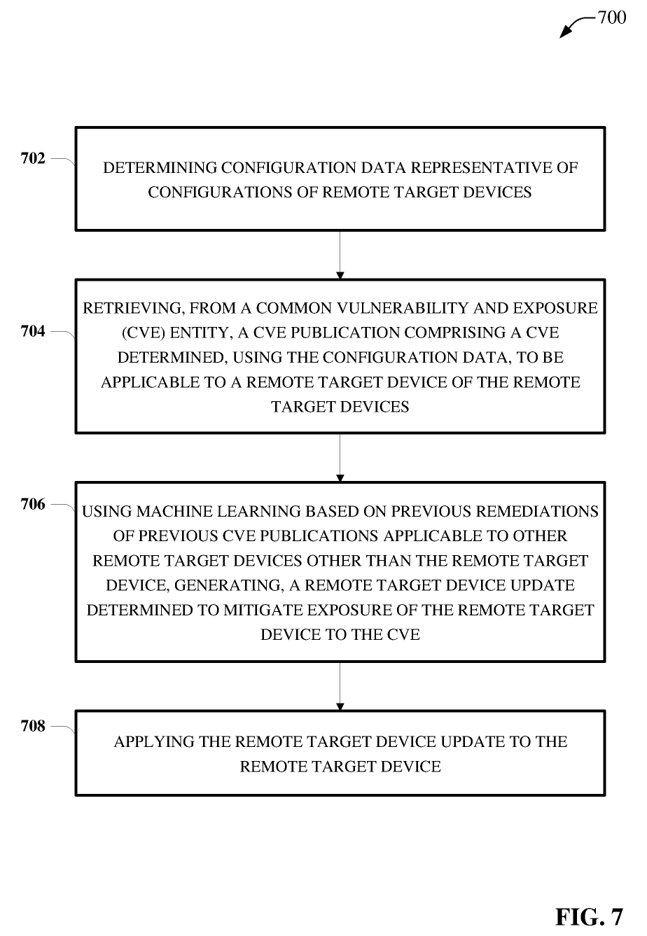

FIG. 7 illustrates a block flow diagram for a process 700 associated with vulnerability oriented configuration management in accordance with one or more embodiments described herein. At 702, the process 700 can comprise determining (e.g., via the status component 202) configuration data representative of configurations of remote target devices (e.g., one or more of the remote devices 112). At 704, the process 700 can comprise retrieving (e.g., via the retrieval component 204), from a common vulnerability and exposure (CVE) entity (e.g., CVE entity 116), a CVE publication (e.g., CVE publication 118) comprising a CVE determined, using the configuration data, to be applicable to a remote target device (e.g., remote device 112) of the remote target devices. At 706, the process 700 can comprise, using machine learning based on previous remediations of previous CVE publications applicable to other remote target devices other than the remote target device (e.g., remote device 112), generating (e.g., via the update component 206), a remote target device update (e.g., remote device update 114) determined to mitigate exposure of the remote target device (e.g., remote device 112) to the CVE. At 708, the process 700 can comprise applying (e.g., via the communication component 208) the remote target device update (e.g., remote device update 114) to the remote target device (e.g., remote device 112).

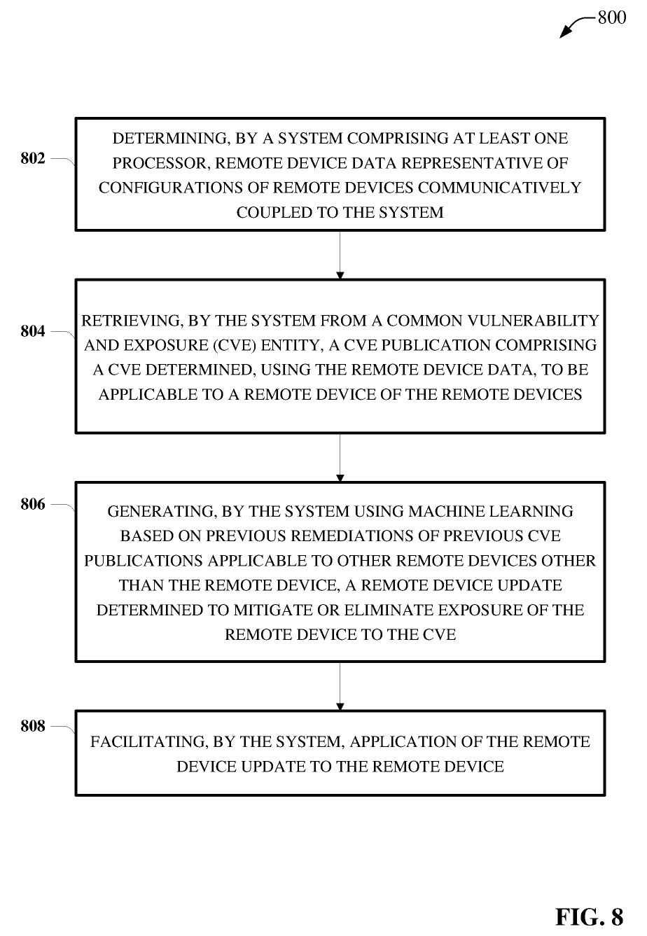

FIG. 8 illustrates a block flow diagram for a process 800 associated with vulnerability oriented configuration management in accordance with one or more embodiments described herein. At 802, the process 800 can comprise determining (e.g., via the status component 202), by a system (e.g., system 102) comprising at least one processor (e.g., processor 106), remote device data representative of configurations of remote devices (e.g., one or more of the remote devices 112) communicatively coupled to the system (e.g., system 102). At 804, the process 80 can comprise retrieving (e.g., via the retrieval component 204), by the system (e.g., system 102) from a common vulnerability and exposure (CVE) entity (e.g., CVE entity 116), a CVE publication (e.g., CVE publication 118) comprising a CVE determined, using the remote device data, to be applicable to a remote device (e.g., remote device 112) of the remote devices. At 806, the process 800 can comprise generating (e.g., via the update component 206), by the system (e.g., system 102) using machine learning based on previous remediations of previous CVE publications applicable to other remote devices other than the remote device (e.g., remote device 112), a remote device update (e.g., remote device update 114) determined to mitigate or eliminate exposure of the remote device (e.g., remote device 112) to the CVE. At 808, the process 800 can comprise facilitating (e.g., via the communication component 208), by the system (e.g., system 102), application of the remote device update (e.g., remote device update 114) to the remote device (e.g., remote device 112).

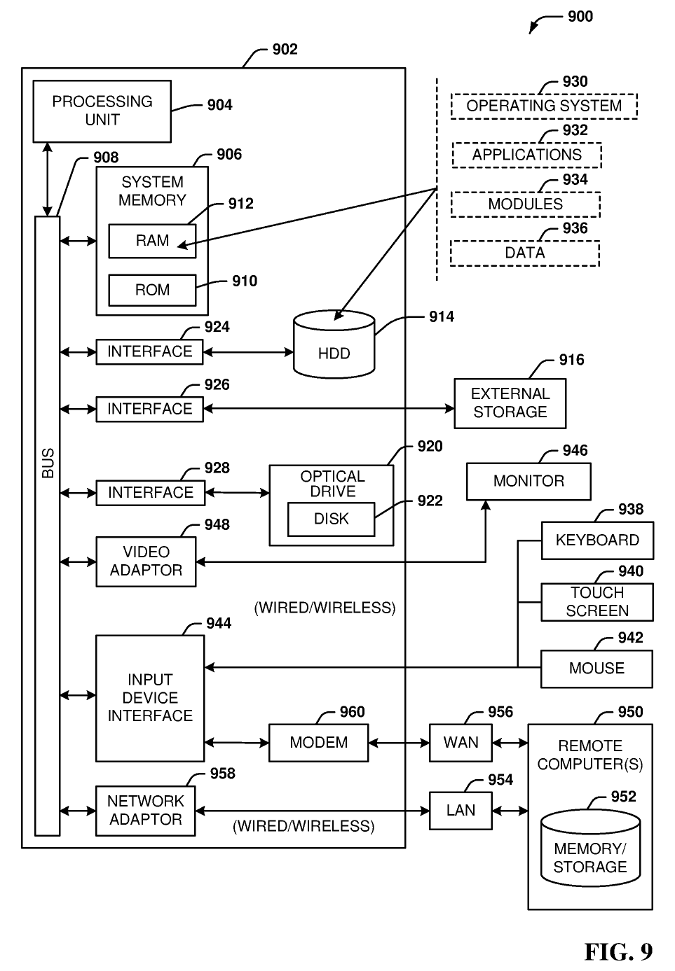

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a disk 922, such as a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or another type of display device can also be connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

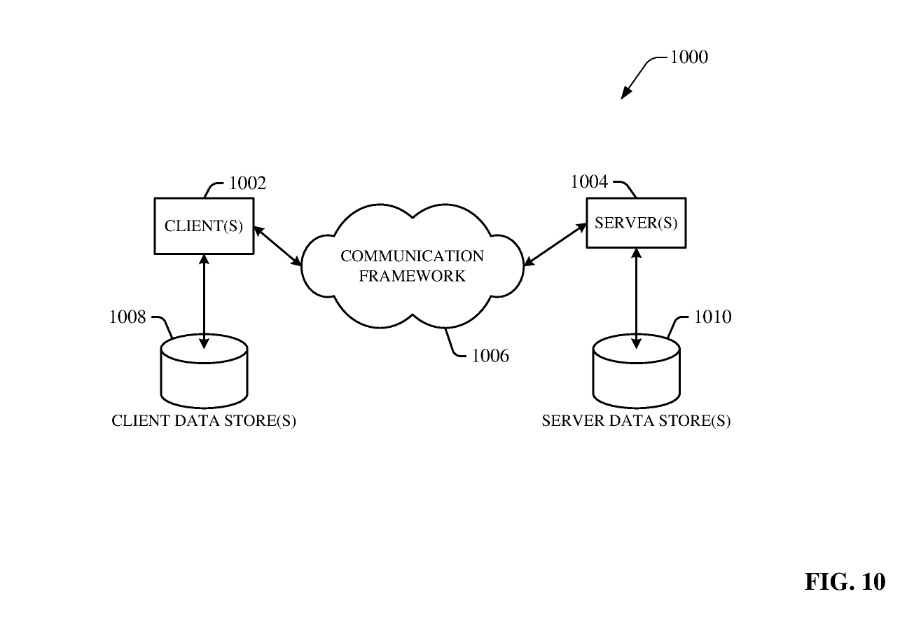

Referring now to FIG. 10, there is illustrated a schematic block diagram of a computing environment 1000 in accordance with this specification. The system 1000 includes one or more client(s) 1002, (e.g., computers, smart phones, tablets, cameras, PDA’s). The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware or hardware in combination with software (e.g., threads, processes, computing devices). The servers 1004 can house threads to perform transformations of media items by employing aspects of this disclosure, for example. One possible communication between a client 1002 and a server 1004 can be in the form of a data packet adapted to be transmitted between two or more computer processes wherein data packets may include coded analyzed headspaces and/or input. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

In one exemplary implementation, a client 1002 can transfer an encoded file, (e.g., encoded media item), to server 1004. Server 1004 can store the file, decode the file, or transmit the file to another client 1002. It is noted that a client 1002 can also transfer uncompressed files to a server 1004 and server 1004 can compress the file and/or transform the file in accordance with this disclosure. Likewise, server 1004 can encode information and transmit the information via communication framework 1006 to one or more clients 1002.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive - in a manner similar to the term “comprising” as an open transition word - without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A system, comprising:
at least one processor; and
at least one memory that stores executable instructions that, when executed by the at least one processor, facilitate performance of operations, comprising:
determining configuration data representative of configurations of remote devices communicatively coupled to the system;
retrieving, from a common vulnerability and exposure (CVE) entity, a CVE publication comprising a CVE determined, using the configuration data, to be applicable to a remote device of the remote devices;
generating, using machine learning comprising reinforcement learning based on previous remediations of previous CVE publications applicable to other remote devices other than the remote device, a remote device update determined to prevent exposure of the remote device to the CVE, wherein the reinforcement learning iteratively improves the remote device update to mitigate or eliminate the exposure of the remote device to the CVE;
validating the remote device update by applying a unit test suite to the remote device update, resulting in a validated remote device update, wherein the remote device update is determined to be a valid remediation in response to the remote device update passing the unit test suite without introducing an error; and
in response to validating the remote device update, applying the validated remote device update to the remote device.

2. (canceled)

3. The system of claim 1, wherein the operations further comprise:
retrieving, from a group of CVE entities comprising the CVE entity, a group of CVE publications comprising CVEs determined to be applicable to the remote device, wherein the group of CVE publications comprises the CVE publication.

4. The system of claim 3, wherein the operations further comprise:normalizing respective risk scores of the CVEs, resulting in normalized risk scores.

5. The system of claim 4, wherein the remote device update is generated based on the normalized risk scores.

6. The system of claim 1, wherein the remote device update comprises a configuration update applicable to the remote device.

7. The system of claim 1, wherein the remote device update comprises a software code change applicable to the remote device.

8. The system of claim 1, wherein the CVE publication is retrieved according to a defined CVE publication refresh frequency policy.

9. The system of claim 1, wherein the remote device update is applied to the remote device via a defined secure shell protocol.

10. A non-transitory machine-readable medium, comprising executable instructions that, when executed by at least one processor, facilitate performance of operations, comprising:
determining configuration data representative of configurations of remote target devices;
retrieving, from a common vulnerability and exposure (CVE) entity, a CVE publication comprising a CVE determined, using the configuration data, to be applicable to a remote target device of the remote target devices;
using machine learning comprising reinforcement learning based on previous remediations of previous CVE publications applicable to other remote target devices other than the remote target device, generating, a remote target device update determined to mitigate exposure of the remote target device to the CVE, wherein the reinforcement learning iteratively improves the remote target device update to mitigate or eliminate the exposure of the remote target device to the CVE;
validating the remote target device update by applying a unit test suite to the remote target device update, resulting in a validated remote target device update, wherein the remote target device update is determined to be a valid remediation in response to the remote target device update passing the unit test suite without introducing an error; and
in response to validating the remote target device update, applying the validated remote target device update to the remote target device.

11. The non-transitory machine-readable medium of claim 10, wherein the operations further comprise:
determining a group of remote target devices, comprising the remote target device, that are applicable to the CVE; and
applying the validated remote target device update to the group of remote target devices.

12. The non-transitory machine-readable medium of claim 10, wherein the operations further comprise:
in response to receiving an acknowledgement from the remote target device that the remote target device update has been successfully applied, registering the remote target device as successfully updated.

13. The non-transitory machine-readable medium of claim 10, wherein the remote target device update is transmitted via a defined secure communication channel.

14. The non-transitory machine-readable medium of claim 10, wherein the remote target device update is applied to a kernel of the remote target device.

15. The non-transitory machine-readable medium of claim 10, wherein the remote target device has been instantiated via cloud computing equipment.

16. The non-transitory machine-readable medium of claim 10, wherein the remote target device comprises a storage appliance or a compute appliance.

17. A method, comprising:
determining, by a system comprising at least one processor, remote device data representative of configurations of remote devices communicatively coupled to the system;
retrieving, by the system from a common vulnerability and exposure (CVE) entity, a CVE publication comprising a CVE determined, using the remote device data, to be applicable to a remote device of the remote devices;
generating, by the system using machine learning comprising reinforcement learning based on previous remediations of previous CVE publications applicable to other remote devices other than the remote device, a remote device update determined to mitigate or eliminate exposure of the remote device to the CVE, wherein the reinforcement learning iteratively improves the remote device update to mitigate or eliminate the exposure of the remote device to the CVE;
validating, by the system, the remote device update by applying a unit test suite to the remote device update, resulting in a validated remote device update, wherein the remote device update is determined to be a valid remediation in response to the remote device update passing the unit test suite without introducing an error; and
in response to validating the remote device update, facilitating, by the system, application of the validated remote device update to the remote device.

18. The method of claim 17, wherein the system and the remote device are located within different respective physical structures.

19. The method of claim 17, wherein the remote device data is repeatedly updated by the system.

20. The method of claim 17, wherein the remote device comprises a server.

21. The method of claim 17, wherein the remote device update comprises a configuration update applicable to the remote device.
